(19) United States
(12) Patent Application Publication
(10) Pub. No.: US 2017/0306243 A1
(43) Pub. Date: Oct. 26, 2017

(54) REACTION AND METHODS OF USING SAME

(71) Applicant: SABIC Global Technologies B.V., Bergen op Zoom (NL)

(72) Inventors: Zeeshan Nawaz, Riyadh (SA); Khalid Karim, Riyadh (SA); Mubarik Ali Bashir, Riyadh (SA); Talal Khaled Al-Shammari, Riyadh (SA)

(21) Appl. No.: 15/526,364

(22) PCT Filed: Nov. 6, 2015
(86) PCT No.: PCT/IB2015/058596

§ 371 Date: May 12, 2017

Related U.S. Application Data
(60) Provisional application No. 62/082,170, filed on Nov. 20, 2014.

(51) Int. Cl. C10G 2/00; B01J 8/06

(52) U.S. Cl. CPC C10G 2/341; B01J 8/067; B01J 2208/065; B01J 2208/00168

(57) ABSTRACT

A reactor for producing desired reaction products has a housing, a plurality of catalyst conduits within the housing, and a plurality of coolant conduits within the housing. The coolant conduits are interspersed among the catalyst conduits, and each catalyst conduit is positioned adjacent to at least two coolant conduits.

### CROSS-REFERENCE TO RELATED APPLICATIONS

The application claims the benefit of U.S. Provisional Application No. 62/082,170, filed Nov. 20, 2014, which application is incorporated herein by reference in its entirety.

### FIELD

This invention relates to reactors for performing chemical reactions to produce desired reaction products and, more particularly, to reactors for providing robust control of chemical reaction parameters.

### BACKGROUND

The Fischer-Tropsch (“FT”) reaction is a catalytic process that involves the conversion of carbon monoxide and hydrogen gas (mixture known as synthesis gas or “syngas”) to a mixture of liquid and gaseous hydrocarbons (—CH₂— molecules). In this process, a wide range of product distributions can be obtained, and selected products are obtained under specific temperature and pressure conditions. Therefore, to obtain selected products, the FT reaction must be performed within a kinetically controlled region. The FT reaction is highly exothermic (about 145 KJ per “CH₂” formed), so rapid removal of heat and temperature control are needed.

For an operable reaction, pressures can range between 1-30 bar, and temperatures can range from 200-350° C. The reactant feed for FT reactions can come from any gasification source, e.g. natural gas, biomass, or coal, but it generally is provided by gaseous hydrocarbons (mostly light olefins, paraffins, alcohols) and liquid hydrocarbons (such as higher olefins, paraffins, alcohols). During the reaction, if the produced heat is not removed continuously, the metallic catalyst can be damaged and the products generated will start to deviate from the desired range and thereby cause problems for downstream processing.

Accordingly, there is a need in the art for reactors that provide more efficient control over reaction parameters while also providing continuous heat removal.

### SUMMARY

Described herein, in one aspect, is a reactor for producing reaction products. The reactor can have a longitudinal axis and comprise a housing, a plurality of catalyst conduits positioned within the housing, and a plurality of coolant conduits positioned within the housing. The housing can have an outer wall surrounding the longitudinal axis of the reactor. Each catalyst conduit can have a longitudinal axis oriented substantially parallel to the longitudinal axis of the reactor and can be configured to receive one or more catalyst materials. Each coolant conduit can have a longitudinal axis oriented substantially parallel to the longitudinal axis of the reactor and can be configured to receive one or more coolant materials. The plurality of coolant conduits can be interspersed among the plurality of catalyst conduits, and each catalyst conduit of the plurality of catalyst conduits can be positioned adjacent to at least two coolant conduits of the plurality of coolant conduits.

In another aspect, described herein is a reactor for producing reaction products. The reactor can have a longitudinal axis and comprise a housing, at least one static mixer, and an injection port. The housing can have an outer wall surrounding the longitudinal axis of the reactor, a first end, and an opposed second end. The second end of the housing can be spaced from the first end of the housing relative to the longitudinal axis of the reactor. The first end of the housing can define an inlet opening configured to receive at least one reactant. The second end of the housing can define an outlet opening configured to receive the reaction products produced within the reactor. Each static mixer of the at least one static mixer can have a mixing chamber and be positioned within the housing between the first and second ends of the housing relative to the longitudinal axis of the reactor. The injection port can be in communication with the mixing chamber of at least one static mixer. The injection port can be configured to receive at least one reactant. The static chamber can divide the housing into first and second compartments relative to the longitudinal axis of the reactor. Each of the first and second compartments can be configured to receive one or more catalyst materials.

Methods of using the described reactors to perform a chemical reaction are also disclosed. In exemplary aspects, the described reactors can be used to perform a reaction selected from the group consisting of a Fischer-Tropsch synthesis, a hydrogenation reaction, and an oxygenation reaction.

In operation, the reactors can provide robust temperature control for chemical reactions while also providing feed composition adjustment flexibility. The reactors can also provide superior operational control to thereby optimize the distribution and/or quality of the reaction products. As further described herein, the reactors can: achieve more uniform cooling flow and more uniform cooling than conventional reactor designs; provide zone-based temperature control; maintain partial pressures within a reactant feed to thereby keep reactant ratios substantially constant; and define distinct stages with coolant entrances and exits to provide for better coolant control within the reactor.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION OF THE FIGURES

These and other features of the preferred embodiments of the invention will become more apparent in the detailed description in which reference is made to the appended drawings wherein:

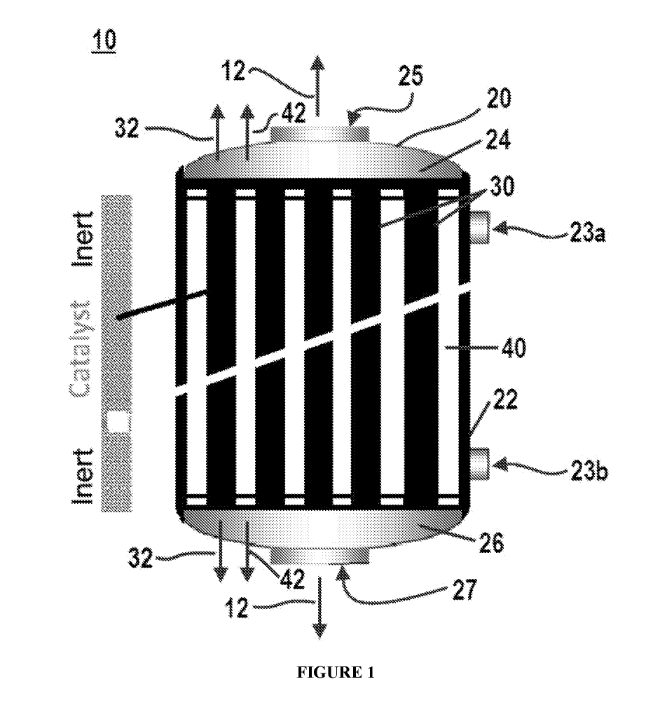

FIG. 1 is cross-sectional side perspective view of an exemplary reactor as disclosed herein.

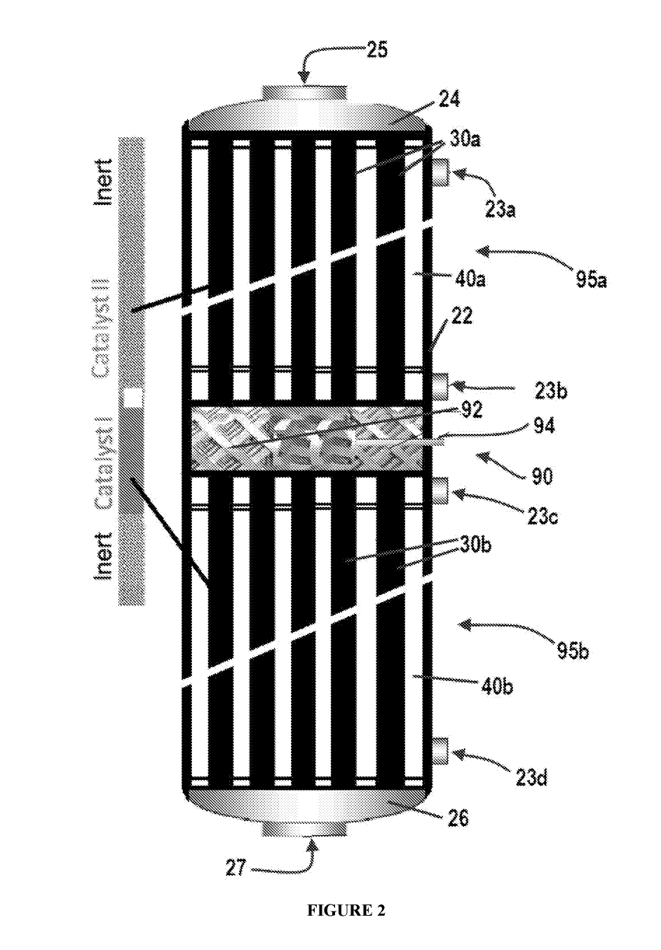

FIG. 2 is a cross-sectional side perspective view of another exemplary reactor as disclosed herein.

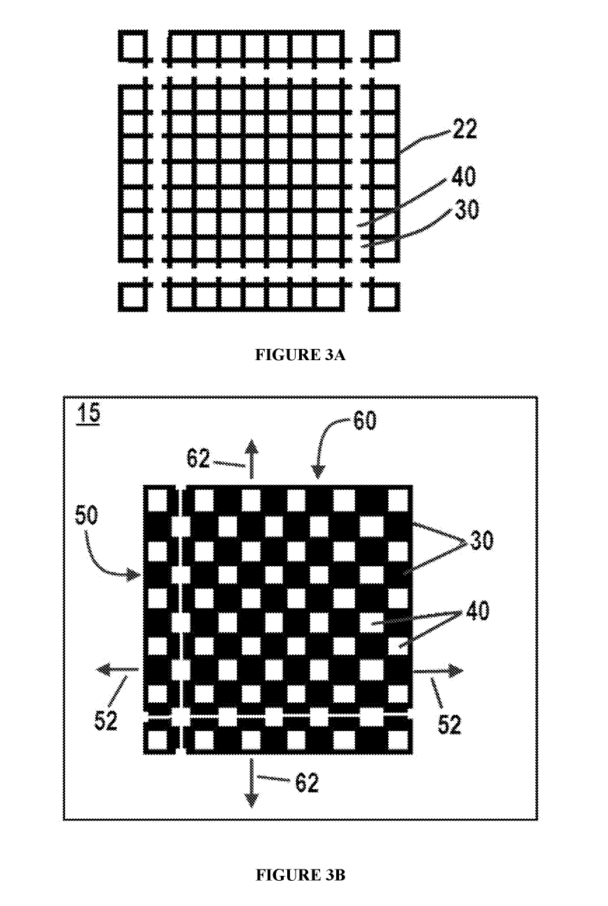

FIG. 3A is a cross-sectional top perspective view of an exemplary reactor as disclosed herein, showing the plurality of conduits within the reactor. FIG. 3B is a cross-sectional top perspective view of the reactor of FIG. 3A, showing the plurality of coolant conduits and the plurality of catalyst conduits within the reactor. As shown in FIGS. 3A-3B, the reactor can have a substantially square cross-sectional profile.

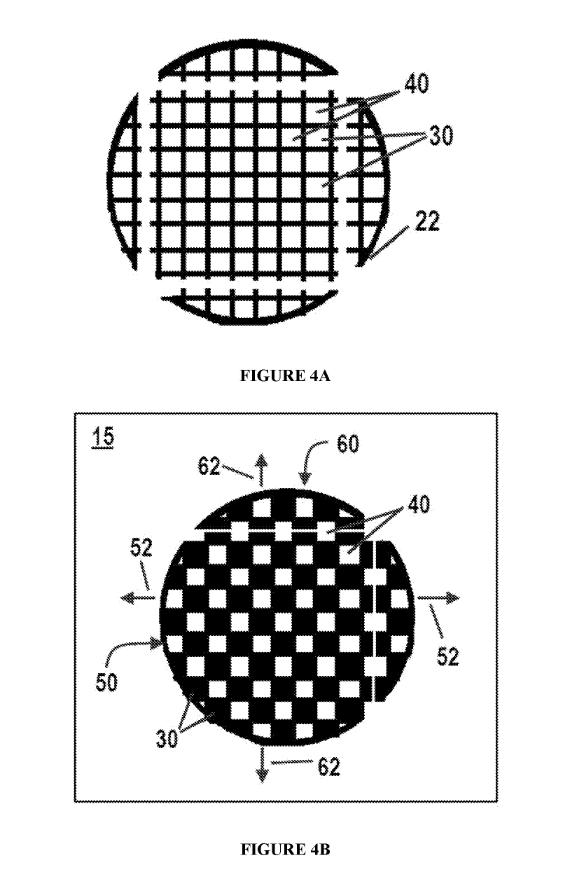

FIG. 4A is a cross-sectional top perspective view of an exemplary reactor as disclosed herein, showing the plurality of conduits within the reactor. FIG. 4B is a cross-sectional top perspective view of the reactor of FIG. 4A, showing the plurality of coolant conduits and the plurality of catalyst conduits within the reactor. As shown in FIGS. 4A-4B, the reactor can have a substantially rounded cross-sectional profile.

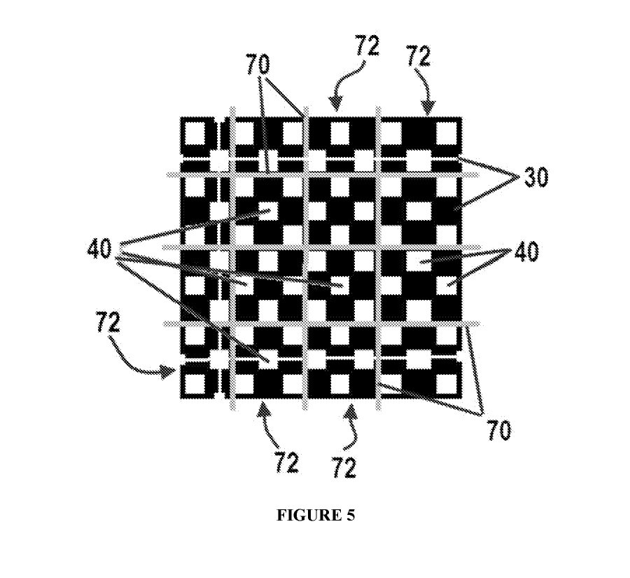

FIG. 5 is a cross-sectional top perspective view of an exemplary reactor as disclosed herein, showing a frame that divides the reactor into a plurality of compartments. As shown, the reactor can have a substantially square cross-sectional profile.

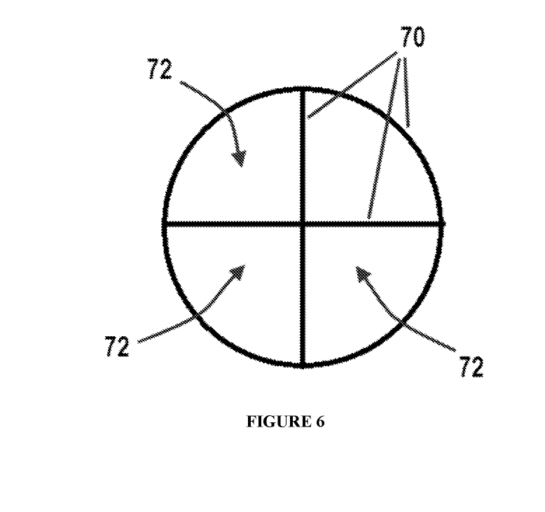

FIG. 6 is cross-sectional top perspective view of an exemplary reactor as disclosed herein, showing a frame that divides the reactor into a plurality of compartments. As shown, the reactor can have a substantially rounded cross-sectional profile.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

All publications mentioned herein are incorporated herein by reference to disclose and describe the methods and/or materials in connection with which the publications are cited.

As used throughout, the singular forms “a,” “an” and “the” include plural referents unless the context clearly dictates otherwise. Thus, for example, reference to “an outlet opening” can include two or more such outlet openings unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The word “or” as used herein means any one member of a particular list and also includes any combination of members of that list.

Described herein, in various aspects, are reactors for performing chemical reactions to produce one or more desired reaction products. In operation, it is contemplated that the reactors can provide robust temperature control for chemical reactions while also providing feed composition adjustment flexibility. It is further contemplated that the reactors can provide superior operational control to thereby optimize the distribution and/or quality of the reaction products. As further described below, it is contemplated that the reactors disclosed herein can achieve more uniform cooling flow and more uniform cooling than conventional reactor designs. It is further contemplated that the reactors disclosed herein can provide zone-based temperature control. It is further contemplated that the reactors disclosed herein can be configured to maintain partial pressures within a reactant feed to thereby keep reactant ratios substantially constant. It is still further contemplated that the reactants can define distinct stages with coolant entrances and exits to provide for better coolant control within the reactor.

Reactors with Catalyst Conduits and Coolant Conduits

Described herein with reference to FIGS. 1-6 is a reactor 10 for producing one or more desired reaction products. The reactor has a longitudinal axis 12. In exemplary aspects, the reactor 10 can comprise a housing 20, a plurality of catalyst conduits 30 positioned within the housing, and a plurality of coolant conduits 40 positioned within the housing. In these aspects, it is contemplated that the plurality of catalyst conduits 30 can comprise from 2 to about 10,000 catalyst conduits, depending upon the dimensions of the catalyst conduits, the coolant conduits 40, and the housing 20. Similarly, it is contemplated that the plurality of coolant conduits 40 can comprise from 2 to about 10,000 coolant conduits, depending upon the dimensions of the coolant conduits, the catalyst conduits 30, and the housing 20. In exemplary aspects, it is contemplated that each respective catalyst conduit 30 of the plurality of catalyst conduits can have a diameter (or maximum width through a center point of the conduit) ranging from about 0.5 inch to about 50 inches. Similarly, it is contemplated that each respective coolant conduit 40 of the plurality of coolant conduits can have a diameter (or maximum width through a center point of the conduit) ranging from about 0.5 inch to about 50 inches.

In one aspect, and as shown in FIGS. 1-2, the housing 20 can have an outer wall 22 that surrounds the longitudinal axis 12 of the reactor. In this aspect, it is contemplated that the outer wall 22 can define a desired cross-sectional profile of the housing 20. Optionally, the housing 20 can have a substantially rectangular (e.g., square) cross-sectional shape. Alternatively, the housing 20 can have a substantially rounded (e.g., circular) cross-sectional shape. However, it is contemplated that the housing 20 can have any cross-sectional shape that permits material flow as disclosed herein.

As shown in FIGS. 1-2, in an additional aspect, the housing 20 of the reactor 10 can have a first end 24 and an opposed second end 26. In this aspect, the second end 26 can be spaced from the first end 24 relative to the longitudinal axis 12 of the reactor 10. In another aspect, the first end 24 of the housing 20 can define at least one inlet opening 25 configured to receive at least one reactant. In this aspect, each inlet opening 25 can be positioned in fluid communication with the plurality of catalyst conduits 30. In a further aspect, the second end 26 of the housing 20 can define at least one outlet opening 27 configured to receive the reaction products produced within the reactor 10. In exemplary aspects, it is contemplated that the at least one outlet opening 27 can be configured to provide flow of exiting gas products at a velocity ranging from about 5 feet per second to about 50 feet per second.

In another aspect, and with reference to FIGS. 1-2, the outer wall 22 of the housing 20 can comprise a plurality of coolant valves 23 that are configured to receive at least one coolant material. In this aspect, the plurality of coolant valves can comprise at least one pair of axially spaced coolant valves, with each pair of axially spaced coolant valves comprising a first coolant valve 23a and a second coolant valve 23b positioned between the first coolant valve and an outlet opening 27 of the housing. Optionally, in one aspect, the first and second coolant valves 23a, 23b of each pair of axially spaced coolant valves can be configured to permit flow of the at least one coolant material from the first coolant valve to the second coolant valve. Alternatively, in another aspect, the first and second coolant valves 23a, 23b of each pair of axially spaced coolant valves can be configured to permit flow of coolant from the second coolant valve to the first coolant valve. In exemplary aspects, the first and second coolant valves 23a, 23b of each pair of axially spaced coolant valves can be configured to permit selective adjustment of coolant flow between a first direction and a second direction. In these aspects, it is contemplated that the first direction can correspond to flow of coolant from the first coolant valve 23a to the second coolant valve 23b, while the second direction can correspond to flow of coolant from the second coolant valve 23b to the first coolant valve 23a. Thus, it is contemplated that the direction of coolant flow can either be in the same direction or the opposite direction of the reactant feed flow.

In another aspect, each catalyst conduit 30 of the plurality of catalyst conduits can have a longitudinal axis 32 oriented substantially parallel to the longitudinal axis 12 of the reactor 10. In use, it is contemplated that each catalyst conduit 30 can be configured to receive one or more catalyst materials. In exemplary aspects, each catalyst conduit 30 can be substantially tubular. However, as shown in FIGS. 3A-5, each catalyst conduit 30 can have a substantially rectangular (e.g., square) cross-sectional profile. More generally, it is contemplated that each catalyst conduit 30 can have any desired cross-sectional profile. For example, in exemplary aspects, it is contemplated that at least one catalyst conduit 30 can have a pentagonal cross-sectional profile. In other exemplary aspects, it is contemplated that at least one catalyst conduit 30 can have a hexagonal cross-sectional profile. In further exemplary aspects, it is contemplated that at least one catalyst conduit 30 can have a different cross-sectional profile than at least one other catalyst conduit within the reactor 10.

In a further aspect, each coolant conduit 40 of the plurality of coolant conduits can have a longitudinal axis 42 oriented substantially parallel to the longitudinal axis 12 of the reactor 10. In use, it is contemplated that each coolant conduit 40 can be configured to receive one or more coolant materials. In exemplary aspects, each coolant conduit 40 can be substantially tubular. However, as shown in FIGS. 3A-5, each coolant conduit 40 can have a substantially rectangular (e.g., square) cross-sectional profile. More generally, it is contemplated that each coolant conduit 40 can have any desired cross-sectional profile. For example, in exemplary aspects, it is contemplated that at least one coolant conduit 40 can have a pentagonal cross-sectional profile. In other exemplary aspects, it is contemplated that at least one coolant conduit 40 can have a hexagonal cross-sectional profile. In further exemplary aspects, it is contemplated that at least one coolant conduit 40 can have a different cross-sectional profile than at least one other coolant conduit within the reactor 10.

In exemplary aspects, the plurality of coolant conduits 40 can be interspersed among the plurality of catalyst conduits 30. In these aspects, it is contemplated that each catalyst conduit 30 of the plurality of catalyst conduits can be positioned adjacent to at least two coolant conduits 40 of the plurality of coolant conduits. Optionally, in further exemplary aspects, the plurality of catalyst conduits 30 can comprise at least one interior catalyst conduit that is positioned adjacent to at least three coolant conduits 40 of the plurality of coolant conduits. In these aspects, and as further disclosed herein, it is contemplated that the plurality of coolant conduits 40 can provide indirect cooling to the plurality of catalyst conduits 30. In still further exemplary aspects, it is contemplated that the plurality of catalyst conduits 30 and the plurality of coolant conduits 40 can optionally be substantially equally distributed within the housing 20. In still further exemplary aspects, it is contemplated that the combined cross-sectional area of the plurality of catalyst conduits 30 can be substantially equivalent to the combined cross-sectional area of the plurality of coolant conduits 40. In operation, it is contemplated that the positioning of the coolant conduits 40 and the catalyst conduits 30 as disclosed herein can achieve more uniform coolant flow and more uniform cooling than conventional reactors.

Optionally, in exemplary aspects, and as shown in FIGS. 3A-4B, within a plane 15 oriented perpendicularly to the longitudinal axis 12 of the reactor 10, the plurality of catalyst conduits 30 and the plurality of coolant conduits 40 can be distributed among a plurality of rows 50. In these aspects, each respective row 50 of the plurality of rows can comprise at least one catalyst conduit 30 and at least one coolant conduit 40. Optionally, it is contemplated that the at least one catalyst conduit 30 and the at least one coolant conduit 40 within each respective row 50 of the plurality of rows can be positioned in an alternating pattern. It is further contemplated that each respective row 50 of the plurality of rows can have a row axis 52. Optionally, in exemplary aspects, the row axis 52 of each respective row 50 can be substantially perpendicular to the longitudinal axes 32, 42 of the catalyst conduits 30 and coolant conduits 40 within the row. In these aspects, it is contemplated that the at least one catalyst conduit 30 of each row 50 can comprise a plurality of catalyst conduits that are spaced apart relative to the row axis 52 of the row. It is further contemplated that the at least one coolant conduit 40 of each row 50 can comprise a plurality of coolant conduits that are spaced apart relative to the row axis 52 of the row.

Optionally, in further exemplary aspects, and as shown in FIGS. 3A-4B, within the plane 15 oriented perpendicularly to the longitudinal axis 12 of the reactor 10, the plurality of catalyst conduits 30 and the plurality of coolant conduits 40 can be distributed among a plurality of columns 60. In these aspects, each respective column 60 of the plurality of columns can comprise at least one catalyst conduit 30 and at least one coolant conduit 40. Optionally, it is contemplated that the at least one catalyst conduit 30 and the at least one coolant conduit 40 within each respective column 60 of the plurality of columns can be positioned in an alternating pattern. It is further contemplated that each respective column 60 of the plurality of columns can have a column axis 62. Optionally, in exemplary aspects, the column axis 62 of each respective column 60 can be substantially perpendicular to the longitudinal axes 32, 42 of the catalyst conduits 30 and coolant conduits 40 within the column. As shown in FIGS. 3B and 4B, the column axis 62 of each respective column 60 can also be substantially perpendicular to the row axes 52 of the plurality of rows 50. In these aspects, it is contemplated that the at least one catalyst conduit 30 of each column 60 can comprise a plurality of catalyst conduits that are spaced apart relative to the column axis 62 of the column. It is further contemplated that the at least one coolant conduit 40 of each column 60 can comprise a plurality of coolant conduits that are spaced apart relative to the column axis 62 of the column.

In additional optional aspects, and with reference to FIGS. 5-6, the reactor 10 can further comprise a grid 70 positioned within the housing 20. In these aspects, the grid 70 can extend relative to the longitudinal axis 12 of the reactor 10 and be shaped to divide the housing 20 into a plurality of compartments 72. In exemplary aspects, each respective compartment 72 of the plurality of compartments can contain at least one catalyst conduit 30 and at least one coolant conduit 40. In these aspects, the grid 70 can be configured to thermally isolate the at least one catalyst conduit 30 and the at least one coolant conduit 40 of each respective compartment 72 from the catalyst conduits and coolant conduits of adjacent compartments. In further exemplary aspects, at least one catalyst conduit 30 within each respective compartment 72 can comprise a thermocouple (or other suitable temperature sensor) configured to adjust coolant flow within the compartment. In these aspects, it is contemplated that each thermocouple can be positioned in communication with a temperature control system of a reactor as is known in the art. It is further contemplated that each thermocouple can be configured to measure the temperature within a respective compartment 72 and to produce a temperature output indicative of the measured temperature within the compartment. It is still further contemplated that each thermocouple can be configured to transmit its temperature outputs to the temperature control system to thereby allow the temperature control system to selectively adjust coolant flow within respective compartments 72 as appropriate to remove hotspots and maintain normal reaction temperatures throughout the reactor 10. Thus, it can be appreciated that the grid 70 provides for zone-based temperature control within the reactor 10.

Optionally, in additional exemplary aspects, the reactor 10 can further comprise at least one divider 90 positioned within the housing 20. In these aspects, it is contemplated that each divider 90 of the at least one divider can extend substantially perpendicularly relative to the longitudinal axis 12 of the reactor 10. It is further contemplated that the at least one divider 90 can divide the housing 20 into a plurality of compartments 95a, 95b positioned relative to the longitudinal axis 12 of the reactor 10. In another aspect, the at least one divider 90 can be configured to thermally isolate each compartment 95a, 95b of the plurality of compartments from its adjacent compartments. In a further aspect, at least one catalyst conduit 30 within each respective compartment 95a, 95b can comprise a thermocouple (or other suitable temperature sensor) configured to adjust coolant flow within the compartment. In this aspect, it is contemplated that each thermocouple can be positioned in communication with a temperature control system of a reactor as is known in the art. It is further contemplated that each thermocouple can be configured to measure the temperature within a respective compartment 95a, 95b and to produce a temperature output indicative of the measured temperature within the compartment. It is still further contemplated that each thermocouple can be configured to transmit its temperature outputs to the temperature control system to thereby allow the temperature control system to selectively adjust coolant flow within respective compartments 95a, 95b as appropriate to remove hotspots and maintain normal reaction temperatures throughout the reactor 10.

Optionally, in still further exemplary aspects, and with reference to FIG. 2, the at least one divider 90 can comprise at least one static mixer. In these aspects, each static mixer can have a mixing chamber 92 and be positioned within the housing 20 between the first and second ends 24, 26 of the housing relative to the longitudinal axis 12 of the reactor 10. In an additional aspect, the reactor 10 can further comprise an injection port 94 positioned in fluid communication with the mixing chamber 92 of the static mixer 90. In this aspect, the injection port 94 can be configured to receive at least one reactant. Optionally, it is contemplated that the at least one static mixer can comprise two or more static mixers, such as, for example and without limitation, two, three, four, five, six, seven, eight, nine, ten, eleven, or twelve static mixers. It is further contemplated that the two or more static mixers can be axially spaced relative to the longitudinal axis 12 of the reactor 10. However, it is also contemplated that two or more of the static mixers can be positioned adjacent one another in a stacked configuration with little or no space between the adjacent static mixers. In exemplary aspects, the at least one static mixer can comprise three or more static mixers. In further exemplary aspects, the at least one static mixer can comprise four or more static mixers.

As shown in FIG. 2, in other exemplary aspects, the at least one static mixer can comprise a single static mixer (shown as element 90 in FIG. 2) that divides the housing 20 into first and second compartments 95a, 95b relative to the longitudinal axis 12 of the reactor 10. In these aspects, the plurality of catalyst conduits can comprise a first plurality of catalyst conduits 30a positioned within the first compartment 95a and a second plurality of catalyst conduits 30b positioned within the second compartment 95b. It is contemplated that the plurality of coolant conduits can comprise a first plurality of coolant conduits 40a positioned within the first compartment 95a and a second plurality of coolant conduits 40b positioned within the second compartment 95b. It is further contemplated that the mixing chamber 94 of the static mixer can be in communication with the first plurality of catalyst conduits 30a and the second plurality of catalyst conduits 30b. In exemplary aspects, it is still further contemplated that the plurality of coolant valves defined by the outer wall 22 of the housing 20 can comprise at least one pair of axially spaced coolant valves 23a, 23b in communication with the first compartment 95a and at least one pair of axially spaced coolant valves 23c, 23d in communication with the second compartment 95b. In these aspects, each pair of axially spaced coolant valves can comprise a first coolant valve 23a, 23c and a second coolant valve 23b, 23d positioned between the first coolant valve and an outlet opening 27 of the housing 20. It is contemplated that the first plurality of catalyst conduits 40a can be positioned in fluid communication with coolant valves 23a, 23b, while the second plurality of catalyst conduits 40b can be positioned in fluid communication with coolant valves 23c, 23d. It is further contemplated that each catalyst conduit 30a of the first plurality of catalyst conduits can have an outlet end positioned in fluid communication with the mixing chamber 94 of the static mixer, while each catalyst conduit 30b of the second plurality of catalyst conduits can have an inlet end positioned in fluid communication with the mixing chamber of the static mixer. In use, it is contemplated that the inter-stage static mixer and injection nozzle 92 can permit stabilization of the partial pressure in the feed of reactant materials (through the inlet opening and within the catalyst conduits), as well as maintenance of a substantially constant ratio of reactants (such as, for example, a substantially constant H₂/CO ratio). Additionally, it is contemplated that the use of discrete coolant valves within each longitudinal compartment 95a, 95b can provide for increased coolant control within the reactor 10.

Optionally, in additional aspects, the at least one divider 90 can comprise a chamber filled with balls comprising alumina or silica. In these aspects, it is contemplated that the ball-filled chamber can be positioned in communication with an injection nozzle as disclosed above with respect to the static mixer. It is further contemplated that the ball-filled chamber can be positioned at an intermediate stage of the chemical reaction in the same manner as the static mixer.

Although disclosed herein as having only two longitudinal compartments 95a, 95b, it is contemplated that the reactor 10 can comprise any number of longitudinal compartments, with adjacent compartments being separated by a divider 90, such as, for example, a static mixer as disclosed herein. It is further contemplated that each respective compartment 95a, 95b can have an overall configuration (including catalyst conduits, coolant conduits, coolant valves, etc.) that is consistent with the configurations of compartments 95a, 95b, as disclosed herein.

It is contemplated that the number of compartments 72, 95a, 95b, the number of dividers 90 (e.g., static mixers), the number of coolant valves 23, the number of catalyst conduits 30, and the number of coolant conduits 40 can be selected depending upon the capacity of the reactor 10 and the level of control of the reaction parameters that is required.

Optionally, in exemplary aspects, it is contemplated that internal surfaces of the housing 20 of the reactor 10 can further comprise internal films positioned proximate the coolant valves and the outer surfaces of the coolant conduits 40 to stabilize reactor equipment in these areas. In further exemplary aspects, it is contemplated that the outer surfaces of the catalyst conduits 30 proximate the outer surfaces of the coolant conduits 40 can be covered with films that are configured to stabilize the interaction between the catalyst conduits 30 and the coolant conduits 40.

In further exemplary aspects, the reactor 10 can comprise a distribution/product collection system as is known in the art. In these aspects, the distribution/product collection system can be positioned within a base portion of the housing 20 to collect the products of the chemical reaction performed within the housing. It is contemplated that the distribution/product collection system can comprise at least one distributor as is known in the art. Optionally, it is further contemplated that the distribution/product collection system can further comprise at least one secondary distributor as is known in the art.

Methods of Using the Reactor with Catalyst Conduits and Coolant Conduits

In use, the disclosed reactors can be used to perform a chemical reaction to thereby produce one or more desired reaction products. In exemplary aspects, the chemical reaction can be selected from the group consisting of a Fischer-Tropsch synthesis, a hydrogenation reaction, and an oxygenation reaction. In these aspects, it is contemplated that the desired reaction products can comprise one or more of paraffins, olefins, alcohols, and the like. In one aspect, a method of performing the chemical reaction can comprise filling the plurality of coolant conduits with a coolant selected from the group consisting of steam, molten salt, and lube oil. In another aspect, the method can comprise positioning at least one catalyst material within selected catalyst tubes of the plurality of catalyst tubes. In this aspect, it is contemplated that the at least one catalyst material can comprise catalyst particles that are configured to form a fixed bed within a respective catalyst tube. In an additional aspect, the method can comprise delivering at least one reactant to the at least one inlet opening. In this aspect, it is contemplated that the at least one reactant can comprise a syngas. It is further contemplated that the syngas can comprise one or more of hydrogen, carbon monoxide, and carbon dioxide. In exemplary aspects, the syngas can comprise hydrogen, carbon monoxide, and carbon dioxide. Optionally, in another aspect, the method can comprise allowing the coolant to boil within at least one coolant conduit of the plurality of coolant conduits. Optionally, in a further aspect, at least one coolant conduit of the plurality of coolant conduits is not filled with coolant. In this aspect, it is contemplated that the at least one coolant conduit that is not filled with coolant can effectively create a draft for low-temperature reactions. In still another aspect, a direction of coolant flow within the reactor can be selectively adjustable. In yet another aspect, the method can further comprise feeding one or more reactants into a static mixer positioned between opposed first and second ends of the housing. In this aspect, the static mixer can be positioned at a location corresponding to an intermediate period between first and second stages of the chemical reaction.

In exemplary aspects, it is contemplated that the ratio of the total combined surface area of the plurality of coolant conduits to the total combined surface area of catalyst within the housing can be selectively adjustable. Thus, in exemplary aspects, it is contemplated that the method can further comprise selectively adjusting the ratio of the total combined surface area of coolant to the total combined surface area of catalyst within the housing. In these aspects, the method can comprise one or more of positioning additional coolant within one or more coolant conduits, removing coolant from one or more coolant conduits, positioning additional catalyst within one or more catalyst conduits, and removing catalyst from one or more catalyst conduits.

Reactors with a Static Mixer Divider

Described herein with reference to FIG. 2 is a reactor 10 for producing desired reaction products, with or without the use of catalyst conduits and coolant conduits as disclosed herein. In exemplary aspects, the reactor 10 can have a longitudinal axis 12 and comprise a housing 20, at least one static mixer 90, and an injection port 94.

In one aspect, the housing can have an outer wall 22 surrounding the longitudinal axis 12 of the reactor 10. In another aspect, the housing 20 can have a first end 24 and an opposed second end 26, with the second end being spaced from the first end relative to the longitudinal axis 12 of the reactor 10. In this aspect, the first end 24 of the housing 20 can define at least one inlet opening 25 configured to receive at least one reactant. It is contemplated that the second end 26 of the housing 20 can define at least one outlet opening 27 configured to receive the reaction products produced within the reactor 10. In exemplary aspects, it is contemplated that the at least one outlet opening 27 can be configured to provide flow of exiting gas products at a velocity ranging from about 5 feet per second to about 50 feet per second.

In an additional aspect, the reactor 10 can comprise at least one static mixer 90. In this aspect, each static mixer 90 can have a mixing chamber 92 and be positioned within the housing 20 between the first and second ends 24, 26 of the housing 20 relative to the longitudinal axis 12 of the reactor 10. In a further aspect, the reactor 10 can comprise an injection port 94 in fluid communication with the mixing chamber 92 of the static mixer 90. In this aspect, the injection port 94 can be configured to receive at least one reactant. Optionally, it is contemplated that the at least one static mixer can comprise two or more static mixers, such as, for example and without limitation, two, three, four, five, six, seven, eight, nine, ten, eleven, or twelve static mixers. It is further contemplated that the two or more static mixers can be axially spaced relative to the longitudinal axis 12 of the reactor 10. However, it is also contemplated that at least two of the static mixers can be positioned adjacent one another in a stacked configuration with little or no space between the adjacent static mixers. In exemplary aspects, the at least one static mixer can comprise three or more static mixers. In further exemplary aspects, the at least one static mixer can comprise four or more static mixers.

Optionally, in exemplary aspects, the at least one static mixer can comprise a single static mixer that divides the housing 20 into first and second compartments 95a, 95b relative to the longitudinal axis 12 of the reactor 10. In these aspects, it is contemplated that each of the first and second compartments 95a, 95b can be configured to receive one or more catalyst materials. It is further contemplated that each compartment 95a, 95b can have a fixed catalyst bed as is known in the art. Optionally, it is further contemplated that the outer wall 22 of the housing 20 can comprise at least one pair of axially spaced coolant valves 23a, 23b in communication with the first compartment 95a and at least one pair of axially spaced coolant valves 23c, 23d in communication with the second compartment 95b. It is still further contemplated that each pair of axially spaced coolant valves can comprise a first coolant valve 23a, 23c and a second coolant valve 23b, 23d positioned between the first coolant valve and an outlet opening 27 of the housing 20.

Although disclosed herein as having only two longitudinal compartments 95a, 95b, it is contemplated that the reactor 10 can comprise any number of longitudinal compartments, with adjacent compartments being separated by a static mixer 90. It is further contemplated that each respective compartment 95 can have an overall configuration (including coolant valves) that is consistent with the configurations of compartments 95a, 95b, as disclosed herein.

Methods of Using the Reactor with a Static Mixer Divider

In use, the disclosed reactors can be used to perform a chemical reaction to thereby produce one or more desired reaction products. In exemplary aspects, the chemical reaction can be selected from the group consisting of a Fischer-Tropsch synthesis, a hydrogenation reaction, and an oxygenation reaction. In these aspects, it is contemplated that the desired reaction products can comprise one or more of paraffins, olefins, alcohols, and the like. In one aspect, a method of performing the chemical reaction can comprise positioning at least one catalyst material within the first and second compartments defined by the static mixer, which is positioned between the opposed first and second ends of the housing. Optionally, in this aspect, a fixed catalyst bed can be created within each compartment. In another aspect, the method can comprise delivering at least one reactant to the at least one inlet opening of the housing. In this aspect, it is contemplated that the at least one reactant can comprise a syngas. It is further contemplated that the syngas can comprise one or more of hydrogen, carbon monoxide, and carbon dioxide. In exemplary aspects, the syngas can comprise hydrogen, carbon monoxide, and carbon dioxide. In one aspect, the method of performing the chemical reaction to produce the one or more desired reaction products can comprise feeding one or more reactants into the static mixer. In this aspect, the static mixer can be positioned at a location corresponding to an intermediate period between first and second stages of the chemical reaction.

### Exemplary Features of the Disclosed Reactors and Methods

In exemplary aspects, the at least one catalyst can comprise at least one Co-based carbon monoxide (CO) conversion catalyst as is known in the art. In other exemplary aspects, it is contemplated that the at least one catalyst can comprise at least one Fe-based CO conversion catalyst as is known in the art. However, it is contemplated that any conventional catalyst for producing a desired reaction product can be used. It is further contemplated that any suitable metal promoter as is known in the art can be used with the at least one catalyst.

In exemplary aspects, the at least one coolant can comprise one or more of boiler feed water (BFW), steam, molten salt, synthetic heat transfer media, mineral oils, organic heat transfer media, aqueous or inorganic or organic brine, molten metals, gases, and the like. However, it is contemplated that the at least one coolant can comprise any material that is conventionally used to provide cooling or heating to a catalyzed reaction, such as, for example and without limitation, a Fischer-Tropsch reaction.

In exemplary aspects, the at least one reactant can comprise a syngas. In these aspects, it is contemplated that the syngas can be formed by contacting a natural gas with steam (and, optionally, carbon dioxide) to produce the syngas using a known reforming process, such as Steam Methane Reforming (SMR), Auto Thermal Reforming (ATR), Partial Oxidation, Adiabatic Pre Reforming (APR), or Gas Heated Reforming (GHR) or any appropriate combination. In further exemplary aspects, the syngas can comprise carbon monoxide, carbon dioxide, or hydrogen, or a combination thereof. In another aspect, the syngas can comprise carbon monoxide and hydrogen. In an additional aspect, it is contemplated that the feed syngas can optionally comprise recycling product components, metallic impurities, sulfur, sulfides, chlorides, organic and/or inorganic acids, water, and the like.

In exemplary aspects, the syngas can be converted into the at least one reaction product by a catalytic process which is usually referred to as the Fischer-Tropsch (FT) process. This is for example described by Van der Laan et al. in Catal. Rev.-Sci. Eng., 41, 1999, p. 255, which is incorporated herein by reference in its entirety. In these aspects, it is contemplated that the at least one reaction product can comprise hydrocarbons. It is further contemplated that the at least one reaction product can comprise at least one olefin, carbon dioxide, and hydrogen. In further exemplary aspects, in addition to the at least one olefin, the at least one reaction product can comprise water, one or more alcohols, or one or more hydrocarbons.

In one aspect, the olefin of the at least one reaction product can comprise C2-C10 hydrocarbons. In another aspect, the olefin can comprise carbons ranging from two carbons to ten carbons, including 3, 4, 5, 6, 7, 8, or 9 carbons. In one aspect, the range of carbon atoms can be derived from any two preceding values. For example, the olefin can comprise carbons ranging from three carbons to nine carbons. In another aspect, the olefin can comprise at least one double bond. In another aspect, the olefin can comprise two double bonds. In a further aspect, the olefin can comprise three double bonds. In still another aspect, the olefin can comprise ethylene, propene, 1-butene, 1-pentene, 1-heptene, 1-hexene, 2-ethyl-hexylene, 2-ethyl-heptene, 1-octene, 1-nonene, or 1-decene, or a combination thereof.

In an additional aspect, the olefin can comprise multiple double bonds. In this aspect, the olefin can be a diolefin. In a further aspect, the olefin can be 1,3-butadiene, 1,4-pentadiene, heptadiene, or a combination thereof. In a further aspect, the olefin can be a cyclic olefin and diolefin. In still another aspect, the olefin can be cyclopentene, cyclopentadiene, cyclohexene, cyclohexadiene, or methyl cyclopentadiene and the like; or a cyclic diolefindiene, e.g., dicyclopentadiene, methylcyclopentadiene dimer and the like.

In further exemplary aspects, the at least one reaction product can comprise one or more paraffins, one or more alcohols, water, or carbon dioxide, or a mixture thereof. In a further aspect, the paraffin can comprise a light paraffin or a heavy paraffin, or a combination thereof. In one aspect, the heavy paraffin can comprise an alkane with 10 or more carbons (C10 and greater). Thus, in this aspect, the heavy paraffin can be a higher-weight reaction product as described herein. In another aspect, the light paraffin can comprise an alkane with 9 or fewer carbons (C9 or less). Thus, in this aspect, the light paraffin can be a lower-weight reaction product as described herein. Heavy paraffin reaction products of C26 and greater can be a wax as described herein.

Optionally, in various aspects, the disclosed reactor and methods can be operated or performed on an industrial scale. In one aspect, the reactor and methods disclosed herein can be configured to produce the disclosed reaction products on an industrial scale. For example, according to further aspects, the reactor and methods can be operated to produce one or more of the disclosed reaction products on an industrial scale.

In various aspects, the disclosed reactor and methods can be operated or performed on any desired time scale or production schedule that is commercially practicable. As one will appreciate, the processing volume for the reactor can be related to reactor or vessel size, which, optionally, can vary from about 0.1 m³ to about 500 m³. It is contemplated that residence time and/or space velocity can be related to catalyst type and/or performance. In another aspect, it is contemplated that the amount of reaction products produced per unit time can be related to the type and/or performance of catalyst.

It is contemplated that the reactor can be configured for continuous, semi batch, or batch wise operation. The residence time and/or weight hourly space velocity (WHSV) can vary depending upon the choice and performance of catalyst and the nature of the chemical reaction. Similarly, the production rate of desired product can also vary. In exemplary syngas conversion reactions, WHSV and residence time can respectively vary between about 100 and about 10,000 Nl/kg/hr and from about 1 to about 50 seconds. In these aspects, the productivity of such a syngas conversion reaction for hydrocarbons can vary between about 0.01 and about 1 kg/kg of Catalyst/hr. However, it is contemplated that the productivity of the reaction can vary further depending upon the choice and performance of catalyst.

In additional aspects, the components of the disclosed reactor can be shaped and sized to permit production of the disclosed reaction products on an industrial scale. Similarly, it is contemplated that the components of the disclosed reactor can comprise materials having material properties that are configured to permit production of the disclosed reaction products on an industrial scale. In further aspects, the components of the disclosed reactor can be shaped and sized to produce the desired reaction products in accordance with the desired time scale or production schedule. Similarly, it is contemplated that the components of the disclosed reactor can comprise materials having material properties that are configured to permit production of the disclosed reaction products in accordance with the desired time scale or production schedule.

Optionally, in exemplary aspects, the disclosed reactor can be operated in a continuous manner. In these aspects, it is contemplated that reactants and other starting materials can enter the reactor and reaction products can exit the reactor without the need for stopping the reactor to empty the contents of the reactor. In exemplary optional aspects, and as further disclosed herein, the reactants and other starting materials can enter a first end of the reactor while the reaction products can exit a second, opposed end of the reactor.

In further exemplary aspects, it is contemplated that the components of the disclosed reactor can comprise any conventional materials that are capable of receiving, housing, and/or contacting reactants, coolants, catalyst materials, products, and the like as disclosed herein.

### Aspects

Aspect 1: A reactor for producing reaction products, the reactor having a longitudinal axis and comprising: a housing having an outer wall surrounding the longitudinal axis of the reactor; a plurality of catalyst conduits positioned within the housing, each catalyst conduit having a longitudinal axis oriented substantially parallel to the longitudinal axis of the reactor and being configured to receive one or more catalyst materials; and a plurality of coolant conduits positioned within the housing, each coolant conduit having a longitudinal axis oriented substantially parallel to the longitudinal axis of the reactor and being configured to receive one or more coolant materials, wherein the plurality of coolant conduits are interspersed among the plurality of catalyst conduits, and wherein each catalyst conduit of the plurality of catalyst conduits is positioned adjacent to at least two coolant conduits of the plurality of coolant conduits.

Aspect 2: The reactor of aspect 1, wherein, within a plane oriented perpendicular to the longitudinal axis of the reactor, the plurality of catalyst conduits and the plurality of coolant conduits are distributed among a plurality of rows.

Aspect 3: The reactor of aspect 2, wherein each respective row of the plurality of rows comprises at least one catalyst conduit and at least one coolant conduit.

Aspect 4: The reactor of aspect 3, wherein the catalyst conduits and coolant conduits within each respective row of the plurality of rows are positioned in an alternating pattern.

Aspect 5: The reactor of any one of aspects 2 to 4, wherein each respective row of the plurality of rows has a row axis, the row axis of each respective row being substantially perpendicular to the longitudinal axes of the catalyst conduits and coolant conduits within the row, wherein the catalyst conduits of each row are spaced apart relative to the row axis of the row, and wherein the coolant conduits of each row are spaced apart relative to the row axis of the row.

Aspect 6: The reactor of any one of aspects 2 to 5, wherein, within the plane oriented perpendicular to the longitudinal axis of the reactor, the plurality of catalyst conduits and the plurality of coolant conduits are distributed among a plurality of columns, each respective column of the plurality of columns having a column axis substantially perpendicular to the longitudinal axes of the conduits within the column and to the row axes of the plurality of rows.

Aspect 7: The reactor of aspect 6, wherein each respective column of the plurality of columns comprises at least one catalyst conduit and at least one coolant conduit.

Aspect 8: The reactor of aspect 7, wherein the catalyst conduits and coolant conduits within each respective column of the plurality of columns are positioned in an alternating pattern.

Aspect 9: The reactor of any one of aspects 6 to 8, wherein the catalyst conduits of each column are spaced apart relative to the column axis of the column, and wherein the coolant conduits of each column are spaced apart relative to the column axis of the column.

Aspect 10: The reactor of any one of aspects 6 to 9, wherein the plurality of catalyst conduits comprises at least one interior catalyst conduit that is positioned adjacent to at least three coolant conduits of the plurality of coolant conduits.

Aspect 11: The reactor of any one of the preceding aspects, wherein the plurality of catalyst conduits and the plurality of coolant conduits are substantially tubular.

Aspect 12: The reactor of any one of the preceding aspects, wherein the housing has a substantially rectangular cross-sectional shape.

Aspect 13: The reactor of any one of the preceding aspects, wherein the housing has a substantially circular cross-sectional shape.

Aspect 14: The reactor of any one of the preceding aspects, wherein the plurality of catalyst conduits and the plurality of coolant conduits are substantially equally distributed within the housing.

Aspect 15: The reactor of any one of the preceding aspects, further comprising a grid positioned within the housing, the grid extending relative to the longitudinal axis of the reactor and being shaped to divide the housing into a plurality of compartments.

Aspect 16: The reactor of aspect 15, wherein each respective compartment of the plurality of compartments contains at least one catalyst conduit and at least one coolant conduit.

Aspect 17: The reactor of aspect 16, wherein the grid is configured to thermally isolate the catalyst conduits and coolant conduits of each respective compartment from the catalyst conduits and coolant conduits of adjacent compartments.

Aspect 18: The reactor of any one of aspects 16 to 17, wherein at least one catalyst conduit within each respective compartment comprises a thermocouple configured to adjust coolant flow within the compartment.

Aspect 19: The reactor of any one of the preceding aspects, further comprising at least one divider positioned within the housing, each divider of the at least one divider extending substantially perpendicularly relative to the longitudinal axis of the reactor, the at least one divider dividing the housing into a plurality of compartments positioned relative to the longitudinal axis of the reactor.

Aspect 20: The reactor of aspect 19, wherein the at least one divider is configured to thermally isolate each compartment of the plurality of compartments from its adjacent compartments.

Aspect 21: The reactor of any one of aspects 19 to 20, wherein at least one catalyst conduit within each respective compartment comprises a thermocouple configured to adjust coolant flow within the compartment.

Aspect 22: The reactor of any one of the preceding aspects, wherein the housing has a first end and an opposed second end, the second end being spaced from the first end relative to the longitudinal axis of the reactor, and wherein the first end of the housing defines an inlet opening configured to receive at least one reactant, the inlet opening being positioned in fluid communication with the plurality of catalyst conduits.

Aspect 23: The reactor of aspect 22, wherein the second end of the housing defines an outlet opening configured to receive the reaction products produced within the reactor.

Aspect 24: The reactor of aspect 23, wherein the outer wall of the housing comprises a plurality of coolant valves, the plurality of coolant valves comprising at least one pair of axially spaced coolant valves, each pair of axially spaced coolant valves comprising a first coolant valve and a second coolant valve positioned between the first coolant valve and the outlet opening of the housing.

Aspect 25: The reactor of aspect 24, wherein the first and second coolant valves of each pair of axially spaced coolant valves are configured to permit flow of coolant from the first coolant valve to the second coolant valve.

Aspect 26: The reactor of aspect 24, wherein the first and second coolant valves of each pair of axially spaced coolant valves are configured to permit flow of coolant from the second coolant valve to the first coolant valve.

Aspect 27: The reactor of any one of aspects 24 to 26, wherein the first and second coolant valves of each pair of axially spaced coolant valves are configured to permit selective adjustment of coolant flow between a first direction and a second direction, the first direction corresponding to flow of coolant from the first coolant valve to the second coolant valve, the second direction corresponding to flow of coolant from the second coolant valve to the first coolant valve.

Aspect 28: The reactor of any one of aspects 22 to 27, further comprising at least one static mixer, the static mixer having a mixing chamber and being positioned within the housing between the first and second ends of the housing relative to the longitudinal axis of the reactor.

Aspect 29: The reactor of aspect 28, further comprising an injection port in communication with the mixing chamber of the static mixer, the injection port being configured to receive at least one reactant.

Aspect 30: The reactor of any one of aspects 28 to 29, wherein the static mixer divides the housing into first and second compartments relative to the longitudinal axis of the reactor, wherein the plurality of catalyst conduits comprise a first plurality of catalyst conduits positioned within the first compartment and a second plurality of catalyst conduits positioned within the second compartment, wherein the plurality of coolant conduits comprise a first plurality of coolant conduits positioned within the first compartment and a second plurality of coolant conduits positioned within the second compartment, wherein the mixing chamber of the static mixer is in communication with the first plurality of catalyst conduits and the second plurality of catalyst conduits.

Aspect 31: The reactor of aspect 30, wherein the outer wall of the housing comprises a plurality of coolant valves, the plurality of coolant valves comprising at least one pair of axially spaced coolant valves in communication with the first compartment and at least one pair of axially spaced coolant valves in communication with the second compartment, each pair of axially spaced coolant valves comprising a first coolant valve and a second coolant valve positioned between the first coolant valve and the outlet opening of the housing.

Aspect 32: A reactor for producing reaction products, the reactor having a longitudinal axis and comprising: a housing having an outer wall surrounding the longitudinal axis of the reactor, a first end, and an opposed second end, the second end being spaced from the first end relative to the longitudinal axis of the reactor, wherein the first end of the housing defines an inlet opening configured to receive at least one reactant, and wherein the second end of the housing defines an outlet opening configured to receive the reaction products produced within the reactor; at least one static mixer, the static mixer having a mixing chamber and being positioned within the housing between the first and second ends of the housing relative to the longitudinal axis of the reactor; and an injection port in communication with the mixing chamber of the static mixer, the injection port being configured to receive at least one reactant, wherein the static chamber divides the housing into first and second compartments relative to the longitudinal axis of the reactor, and wherein each of the first and second compartments is configured to receive one or more catalyst materials.

Aspect 33: The reactor of aspect 32, wherein the outer wall of the housing comprises a plurality of coolant valves, the plurality of coolant valves comprising at least one pair of axially spaced coolant valves in communication with the first compartment and at least one pair of axially spaced coolant valves in communication with the second compartment, each pair of axially spaced coolant valves comprising a first coolant valve and a second coolant valve positioned between the first coolant valve and the outlet opening of the housing.

Aspect 34: The reactor of any one of aspects 32 to 33, wherein the at least one static mixer comprises two or more static mixers.

Aspect 35: The reactor of aspect 34, wherein the two or more static mixers are axially spaced relative to the longitudinal axis of the reactor.

Aspect 36: A method of performing a reaction, comprising: using the reactor of any of aspects 1 to 31 to perform a reaction selected from the group consisting of a Fischer-Tropsch synthesis, a hydrogenation reaction, and an oxygenation reaction.

Aspect 37: The method of aspect 36, further comprising filling the plurality of coolant conduits with a coolant selected from the group consisting of steam, molten salt, and lube oil.

Aspect 38: The method of aspect 37, further comprising allowing the coolant to boil within at least one coolant conduit of the plurality of coolant conduits.

Aspect 39: The method of aspect 36, wherein at least one coolant conduit of the plurality of coolant conduits is not filled with coolant.

Aspect 40: The method of aspect 37, wherein a direction of coolant flow within the reactor is selectively adjustable.

Aspect 41: The method of aspect 36, further comprising feeding one or more reactants into a static mixer positioned between opposed first and second ends of the housing.

Aspect 42: The method of aspect 41, wherein the static mixer is positioned at a location corresponding to an intermediate period between first and second stages of the reaction.

Aspect 43: A method of performing a reaction, comprising: using the reactor of any of aspects 32 to 35 to perform a reaction selected from the group consisting of a Fischer-Tropsch synthesis, a hydrogenation reaction, and an oxygenation reaction.

Aspect 44: The method of aspect 43, further comprising feeding one or more reactants into the static mixer.

Aspect 45: The method of any one of aspects 43 to 44, wherein the static mixer is positioned at a location corresponding to an intermediate period between first and second stages of the reaction.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

1. A reactor for producing reaction products, the reactor having a longitudinal axis and comprising:
a housing having an outer wall surrounding the longitudinal axis of the reactor;
a plurality of catalyst conduits positioned within the housing, each catalyst conduit having a longitudinal axis oriented substantially parallel to the longitudinal axis of the reactor and being configured to receive one or more catalyst materials; and
a plurality of coolant conduits positioned within the housing, each coolant conduit having a longitudinal axis oriented substantially parallel to the longitudinal axis of the reactor and being configured to receive one or more coolant materials,
wherein the plurality of coolant conduits are interspersed among the plurality of catalyst conduits, and wherein each catalyst conduit of the plurality of catalyst conduits is positioned adjacent to at least two coolant conduits of the plurality of coolant conduits.

2. The reactor of claim 1, wherein, within a plane oriented perpendicular to the longitudinal axis of the reactor, the plurality of catalyst conduits and the plurality of coolant conduits are distributed among a plurality of rows.

3. The reactor of claim 2, wherein each respective row of the plurality of rows comprises at least one catalyst conduit and at least one coolant conduit.

4. (canceled)

5. The reactor of claim 2, wherein each respective row of the plurality of rows has a row axis, the row axis of each respective row being substantially perpendicular to the longitudinal axes of the catalyst conduits and coolant conduits within the row, wherein the catalyst conduits of each row are spaced apart relative to the row axis of the row, and wherein the coolant conduits of each row are spaced apart relative to the row axis of the row.

6. The reactor of claim 5, wherein, within the plane oriented perpendicular to the longitudinal axis of the reactor, the plurality of catalyst conduits and the plurality of coolant conduits are distributed among a plurality of columns, each respective column of the plurality of columns having a column axis substantially perpendicular to the longitudinal axes of the conduits within the column and to the row axes of the plurality of rows, wherein each respective column of the plurality of columns comprises at least one catalyst conduit and at least one coolant conduit, and wherein the catalyst conduits of each column are spaced apart relative to the column axis of the column, and wherein the coolant conduits of each column are spaced apart relative to the column axis of the column.

7. (canceled)

8. (canceled)

9. (canceled)

10. The reactor of claim 5, wherein the plurality of catalyst conduits comprises at least one interior catalyst conduit that is positioned adjacent to at least three coolant conduits of the plurality of coolant conduits.

11. (canceled)

12. (canceled)

13. (canceled)

14. (canceled)

15. The reactor of claim 1, further comprising a grid positioned within the housing, the grid extending relative to the longitudinal axis of the reactor and being shaped to divide the housing into a plurality of compartments, wherein each respective compartment of the plurality of compartments contains at least one catalyst conduit and at least one coolant conduit, and wherein the grid is configured to thermally isolate the catalyst conduits and coolant conduits of each respective compartment from the catalyst conduits and coolant conduits of adjacent compartments.

16. (canceled)

17. (canceled)

18. The reactor of claim 15, wherein at least one catalyst conduit within each respective compartment comprises a thermocouple configured to adjust coolant flow within the compartment.

19. The reactor of claim 1, further comprising at least one divider positioned within the housing, each divider of the at least one divider extending substantially perpendicularly relative to the longitudinal axis of the reactor, the at least one divider dividing the housing into a plurality of compartments positioned relative to the longitudinal axis of the reactor, wherein the at least one divider is configured to thermally isolate each compartment of the plurality of compartments from its adjacent compartments, and wherein at least one catalyst conduit within each respective compartment comprises a thermocouple configured to adjust coolant flow within the compartment.

20. (canceled)

21. The reactor of claim 19, wherein at least one catalyst conduit within each respective compartment comprises a thermocouple configured to adjust coolant flow within the compartment.

22. The reactor of claim 1, wherein the housing has a first end and an opposed second end, the second end being spaced from the first end relative to the longitudinal axis of the reactor, and wherein the first end of the housing defines an inlet opening configured to receive at least one reactant, the inlet opening being positioned in fluid communication with the plurality of catalyst conduits.

23. The reactor of claim 22, wherein the second end of the housing defines an outlet opening configured to receive the reaction products produced within the reactor.

24. The reactor of claim 23, wherein the outer wall of the housing comprises a plurality of coolant valves, the plurality of coolant valves comprising at least one pair of axially spaced coolant valves, each pair of axially spaced coolant valves comprising a first coolant valve and a second coolant valve positioned between the first coolant valve and the outlet opening of the housing.

25. (canceled)

26. (canceled)

27. (canceled)

28. The reactor of claim 22, further comprising at least one static mixer, the static mixer having a mixing chamber and being positioned within the housing between the first and second ends of the housing relative to the longitudinal axis of the reactor.

29. The reactor of claim 28, further comprising an injection port in communication with the mixing chamber of the static mixer, the injection port being configured to receive at least one reactant.

30. The reactor of claim 28, wherein the static mixer divides the housing into first and second compartments relative to the longitudinal axis of the reactor, wherein the plurality of catalyst conduits comprise a first plurality of catalyst conduits positioned within the first compartment and a second plurality of catalyst conduits positioned within the second compartment, wherein the plurality of coolant conduits comprise a first plurality of coolant conduits positioned within the first compartment and a second plurality of coolant conduits positioned within the second compartment, wherein the mixing chamber of the static mixer is in communication with the first plurality of catalyst conduits and the second plurality of catalyst conduits.

31. The reactor of claim 30, wherein the outer wall of the housing comprises a plurality of coolant valves, the plurality of coolant valves comprising at least one pair of axially spaced coolant valves in communication with the first compartment and at least one pair of axially spaced coolant valves in communication with the second compartment, each pair of axially spaced coolant valves comprising a first coolant valve and a second coolant valve positioned between the first coolant valve and the outlet opening of the housing.

32. (canceled)

33. (canceled)

34. (canceled)

35. (canceled)

36. A method of performing a reaction, comprising:
using a reactor to perform a reaction selected from the group consisting of a Fischer-Tropsch synthesis, a hydrogenation reaction, and an oxygenation reaction, the reactor having a longitudinal axis and comprising:
a housing having an outer wall surrounding the longitudinal axis of the reactor;
a plurality of catalyst conduits positioned within the housing, each catalyst conduit having a longitudinal axis oriented substantially parallel to the longitudinal axis of the reactor and being configured to receive one or more catalyst materials; and
a plurality of coolant conduits positioned within the housing, each coolant conduit having a longitudinal axis oriented substantially parallel to the longitudinal axis of the reactor and being configured to receive one or more coolant materials,
wherein the plurality of coolant conduits are interspersed among the plurality of catalyst conduits, and wherein each catalyst conduit of the plurality of catalyst conduits is positioned adjacent to at least two coolant conduits of the plurality of coolant conduits.

37. The method of claim 36, further comprising:
filling the plurality of coolant conduits with a coolant selected from the group consisting of steam, molten salt, and lube oil; and
allowing the coolant to boil within at least one coolant conduit of the plurality of coolant conduits.

38. (canceled)

39. (canceled)

40. (canceled)

41. The method of claim 37, further comprising feeding one or more reactants into a static mixer positioned between opposed first and second ends of the housing.

42. (canceled)

43. (canceled)

44. (canceled)

45. (canceled)
